(19) United States
(12) Patent Application Publication
(10) Pub. No.: US 2020/0025590 A1
(43) Pub. Date: Jan. 23, 2020

(54) CONNECTION STRUCTURE, TOUCH SENSOR AND METHOD FOR FORMING CONNECTION STRUCTURE

(71) Applicant: KABUSHIKI KAISHA TOKAI RIKA DENKI SEISAKUSHO, Aichi (JP)

(72) Inventor: Hajime ITO, Aichi (JP)

(73) Assignee: Kabushiki Kaisha Tokai Rika Deniki Seisakusho, Aichi (JP)

(21) Appl. No.: 16/336,265

(22) PCT Filed: Sep. 27, 2017
(86) PCT No.: PCT/JP2017/035060

§ 371 Date: Mar. 25, 2019

(30) Foreign Application Priority Data
Oct. 11, 2016 (JP) 2016-199794

(51) Int. Cl. G01D 5/24; H01R 4/06; H01R 43/04; F16B 5/04; F16B 19/08; B62D 1/06; B62D 1/04

(52) U.S. Cl. CPC G01D 5/2405; H01R 4/06; H01R 43/04; B62D 1/046; F16B 19/08; B62D 1/06; F16B 5/04

(57) ABSTRACT

A connection structure includes a terminal with an electric wire attached thereto and with an insertion hole, a sheet-shaped conductive member including a cut portion formed by being cut in to be pierced from a front surface to a rear surface thereof, and a rivet swaged while inserting a swaged portion into the insertion hole and the cut portion and rolling together the conductive member of the cut portion to have a conduction between the terminal and the conductive member.

### CROSS REFERENCE TO RELATED APPLICATIONS

This application claims the benefit of priority of Japanese patent application No. 2016-199794, and the entire contents of Japanese patent application No. 2016-199794 are incorporated herein by reference.

### TECHNICAL FIELD

The present invention relates to a connection structure, a touch sensor, and a connection structure forming method.

### BACKGROUND ART

There is known an extremely thin layered member conduction method for establishing an electrical continuity through an extremely thin layered member made of a plurality of layered extremely thin metallic pieces (for example, refer to Patent Document 1).

This extremely thin layered member conduction method includes a step of setting an extremely thin layered member on a cutting die including a cutting hole and driving a Piercing rivet supported by a stem into the extremely thin layered member, a step of press fitting a caulking punch into the piercing rivet driven into the extremely thin layered member from a distal end of the piercing rivet and caulking the piercing rivet, and a step of removing cutting dust remaining on and adhering to an inner circumferential surface of the piercing rivet.

### CITATION LIST

### Patent Document

Patent Document 1: JP 2002/93489 A

### SUMMARY OF INVENTION

### Technical Problem

With the extremely thin layered member conduction method disclosed in Patent Document 1, since cutting dust is produced as mill ends, not only do the produced mill ends constitute waste materials, but also a recovery step of recovering the produced mill ends becomes necessary to suppress the occurrence of a drawback caused by the mill ends, leading to a problem in that the production cost is increased.

An object of the invention is to provide a connection structure, a touch sensor, and a connection structure forming method which can suppress an increase in production cost by producing no mill end.

### Solution to Problem

As an embodiment, the invention provides a connection structure, a touch sensor, and a connection structure forming method which will be described under [1] to [7] below.

[1] A connection structure including, a terminal attached with an electric wire and including an insertion hole, a conductive member having sheet-shape, the conductive member including a cut portion formed by cutting through the conductive member from a front surface to a rear surface to pierce the conductive member, and a rivet configured to establish an electrical continuity between the terminal and the conductive member, the rivet caulked by entraining the conductive member around the cut portion with a caulking portion being inserted through the insertion hole and the cut portion.

[2] The connection structure according to [1] above, wherein the conductive member is a conductive cloth or a conductive sheet.

[3] The connection structure according to [1] above, wherein the conductive member is a conductive cloth having a mesh configuration.

[4] The connection structure according to any one of [1] to [3] above, wherein the cut portion in the conductive member is formed by making one or a plurality of cuts rectilinearly or curvilinearly, the plurality of cuts intersecting.

[5] A touch sensor including the connection structure according to any one of [1] to [4] above.

[6] A connection structure forming method, including, forming a cut portion in a conductive member having sheet-shape by cutting through the conductive member from a front surface to a rear surface to pierce the conductive member, disposing a terminal attached with an electric wire and including an insertion hole on a front surface side of the conductive member, inserting a caulking portion of a rivet through the insertion hole and the cut portion and causing the conductive member around the cut portion to extend towards a rear surface side, and caulking the rivet and deforming a distal end of the caulking portion, entraining the conductive member around the cut portion extending towards the rear surface side of the conductive member to establish an electrical continuity between the terminal and the conductive member.

[7] The connection structure forming method according to [6] above, wherein the cut portion in the conductive member is formed by making one or a plurality of cuts rectilinearly or curvilinearly, the plurality of cuts intersecting.

### Advantageous Effects of Invention

According to the embodiment of the invention, the connection structure, the touch sensor, and the connection structure forming method can be provided which can suppress an increase in production cost by producing no mill end.

### BRIEF DESCRIPTION OF DRAWINGS

FIG. 1 is a schematic diagram illustrating an example of a connection structure according to a first embodiment.

FIG. 2A is a cross-sectional view illustrating an example of a rivet of the connection structure according to the first embodiment before the rivet is caulked.

FIG. 2B is a cross-sectional view illustrating an example after the rivet is caulked.

FIG. 3A is a schematic diagram illustrating a modified example of a cut portion of the connection structure according to the first embodiment.

FIG. 3B is a schematic diagram illustrating another modified example of a cut portion of the connection structure according to the first embodiment.

FIG. 4A is a schematic diagram illustrating an example of a connection structure according to a second embodiment before it is built up.

FIG. 4B is a schematic diagram illustrating an example where the connection structure is built up.

FIG. 5A is a cross-sectional view of the example of the connection structure according to the second embodiment.

FIG. 5B is a schematic diagram illustrating an example of a steering wheel where the connection structure is disposed.

### DESCRIPTION OF EMBODIMENT

### Overview of Embodiments

A connection structure according to an embodiment includes a terminal attached with an electric wire and including an insertion hole, a conductive member having sheet-shape, the conductive member including a cut portion formed by cutting through the conductive member from a front surface to a rear surface to pierce the conductive member, and a rivet configured to establish an electrical continuity between the terminal and the conductive member, the rivet caulked by entraining the conductive member around the cut portion with a caulking portion being inserted through the insertion hole and the cut portion.

In this connection structure, a hole through which the rivet is inserted in the conductive member is not formed, but a cut is formed, so that the rivet is inserted through the cut to be caulked. Consequently, no mill end is produced, thereby making it possible to suppress an increase in production cost.

### First Embodiment

### Summary of Connection Structure 1

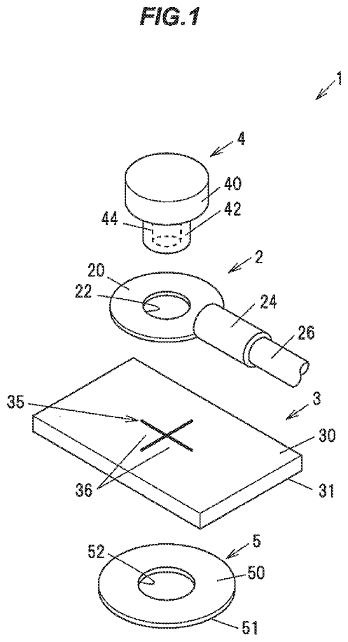

FIG. 1 is a schematic diagram illustrating an example of a connection structure according to a first embodiment. In the drawings associated with the following embodiments, ratios between elements in the drawings may be different from the actual ratios.

This connection structure 1 includes, as illustrated in FIG. 1, a terminal 2 attached with electric wire 26 and including an insertion hole 22, a conductive member 3 having sheet-shape, the conductive member 3 including a cut portion 35 formed by cutting through the conductive member from a front surface 30 to a rear surface 31 to pierce the conductive member 3, and a rivet 4 configured to establish an electrical continuity between the terminal 2 and the conductive member 3, the rivet 4 caulked by entraining the conductive member 3 (an entrained portion 36) around the cut portion 35 with a caulking portion 42 being inserted through the insertion hole 22 and the cut portion 35.

### Configuration of Terminal 2

The terminal 2 is, for example, a round crimping terminal including a circular connecting portion 20. This terminal 2 is termed using, for example, oxygen-fee copper, and a tin plating is applied to a surface thereof. This terminal 2 includes the connecting portion 20 and the crimping portion 24, as illustrated in FIG. 1.

The connecting portion 20 has a circular disc-like shape. Then, the insertion hole 22, through which the rivet 4 is inserted, is formed in the connecting portion 20 at a center. The crimping portion 24 has a cylindrical shape, and the electric wire 26 is inserted into the cylinder. Then, the crimping portion 24 is caulked by a tool to be electrically connected with the electric wire 26. This electric wire 26 is electrically connected with, for example, an electronic control unit (ECU) of a vehicle.

### Configuration of Conductive Member 3

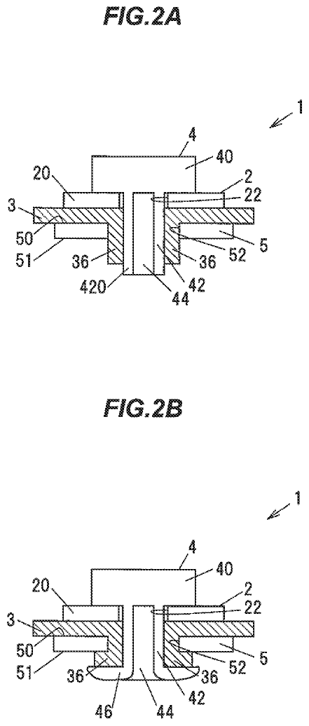

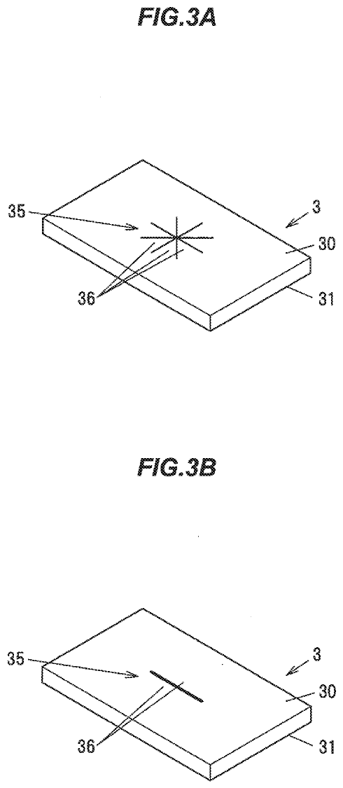

FIG. 2A is a cross-sectional view illustrating an example of the rivet of the connection structure according to the first embodiment before the rivet is caulked, and FIG. 2B is a cross-sectional view illustrating an example after the rivet is caulked. FIGS. 3A and 3B are schematic diagrams illustrating a modified example of a cut portion of the connection structure according to the first embodiment. In FIGS. 2A and 2B, the conductive member 3 is shaded with oblique lines.

The conductive member 3 has, for example, an elongated sheet-like shape. Additionally, the conductive member 3 is a conductive cloth or a conductive sheet. The conductive cloth is, for example, thin cloth woven using conductive threads. The conductive sheet is, for example, a sheet in which a thin metallic film is formed on a soft sheet material or a sheet formed of conductive rubber.

The cut portion 35 is formed in the conductive member 3 by a laser beam or a blade. The cut portion 35 has a shape to allow the rivet 4 to pass through. The cut portion 35 illustrated in FIG. 1 is formed into a cruciform cut by making two cuts in such a way as to intersect each other. A portion between the vertical cut and the horizontal cut at the cut portion 35 constitutes an entrained portion 36.

Four entrained portions 36 are formed. Then, as illustrated in FIGS. 2A and 2B, the entrained portions 36 are entrained between a washer 5 and a deformed portion 46 of the caulking portion 42 of the rivet 4 after the rivet 4 has been caulked.

Since the cut portion 35 is formed by making the cuts in the conductive member 3, no mill end is produced. The cut portion 35 can have various shapes as long as a resulting cut portion allows the rivet 4 to pass through.

A cut portion 35 illustrated in FIG. 3A as a modified example is formed by making four cuts in such a way as to intersect one another. As a result, eight entrained portions 36 are formed in the cut portion 35. A cut portion 35 illustrated in FIG. 3B as another modified example is formed by making one cut. As a result, two entrained portions 36 are formed in the resulting cut portion 35.

While these cut portions 35 are formed by making the rectilinear cut or cuts, the configuration is not limited thereto, and hence, the cut portions 35 may be formed by making a curvilinear cut or cuts. The number of cuts may be single or plural.

### Configuration of Rivet 4

The rivet 4 is, as an example, a hollow rivet as illustrated in FIG. 1 and is formed using aluminum, iron, or stainless steel. This rivet 4 includes a head portion 40 and the caulking portion 42. The head portion 40 has, for example, a circular disc-like shape. The caulking portion 42 has a cylindrical shape including a caulking cavity portion 44.

### Configuration of Washer 5

The washer 5 has a circular disc-like shape including an insertion hole 52 formed at a center. As illustrated in FIGS. 2A and 2B, this insertion hole 52 has a diameter greater than a diameter of the caulking portion 42 of the rivet 4. This is because the entrainment of the entrained portions 36 of the conductive member 3 between the caulking portion 42 and the insertion hole 52 is facilitated. The entrainment of the conductive member 3 does not occur, for example, when a circular hole through which the caulking portion 42 is inserted is formed in the conductive member 3.

Hereinafter, a method for caulking the connection structure 1 will be described.

### Caulking Method

The connecting portion 20 of the terminal 2 is disposed on a front surface 30 side, and the washer 5 is disposed on a rear surface 31 side of the conductive member 3. Next, as illustrated in FIG. 2A, the caulking portion 42 of the rivet 4 is inserted through the insertion hole 22 in the terminal 2, the cut portion 35 in the conductive member 3 and the insertion hole 52 in the washer 5.

As illustrated in FIG. 2A, the entrained portions 36 of the conductive member 3 are inserted through the insertion hole 52 in the washer 5 in association with the insertion of the caulking portion 42.

Next, as illustrated in FIG. 2B, after a pin is inserted into the caulking cavity portion 44 of the rivet 4, the head portion 40 and the caulking portions 42 are pressed to be caulked to plastically deform a distal end portion 420 of the caulking portion 42, whereby the deformed portion 46 is formed. Caulking the rivet 4 in the way described above integrates the terminal 2 with the conductive member 3 to establish an electrical continuity between the terminal 2 and the conductive member 3, whereby the connection structure 1 is formed.

As illustrated in FIG. 2B, the entrained portions 36 are entrained from a front surface 50 side to a rear surface 51 side of the washer 5 through the insertion hole 52. Consequently, as illustrated in FIG. 2B, an area where the rivet 4 and the conductive member 3 are brought into close contact with each other is wider than a case where no entrained portion is provided.

### Effects of First Embodiment

With the connection structure 1 according to the embodiment, no mill end is produced, thereby making it possible to suppress an increase in production cost. Specifically, with the connection structure 1, since the rivet 4 is inserted through the cut portion 35 formed by making the cut or cuts in the conductive member 3, mill ends are not produced, which would otherwise be produced when cutting (removing) the conductive member into the shape of a hole to form a hole through which the rivet is passed. Then, with the connection structure 1, since no mill end is produced, the necessity of a step of collecting mill ends is obviated, whereby an increase in production cost is suppressed.

With the connection structure 1, since the cut portion 35 can be formed in a step of cutting the conductive member 3 into a desired shape, the number of steps is reduced to thereby suppress an increase in production cost.

With the connection structure 1, since the rivet 4 is caulked with entraining the entrained portions 36, the degree to which the conductive member 3 and the rivet 4 are brought into contact with each other is increased when compared with the case where a hole shape is cut out of the conductive member. Consequently, with the construction structure 1, the strength against rotational torque with which the terminal 2 is rotated relative to the conductive member 3 is high, whereby a continuity failure hardly occurs even when great rotational torque is exerted on the terminal 2. With the connection structure 1, since the strength against rotational torque is high, the degree of freedom in handling the connection structure 1 is high.

### Second Embodiment

A second embodiment differs from the first embodiment in that a conductive member 3 has a mesh configuration.

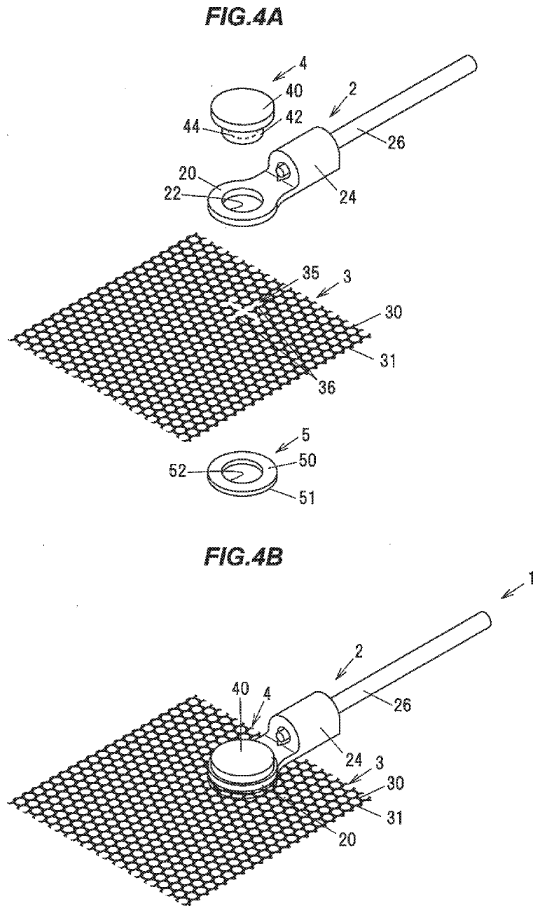

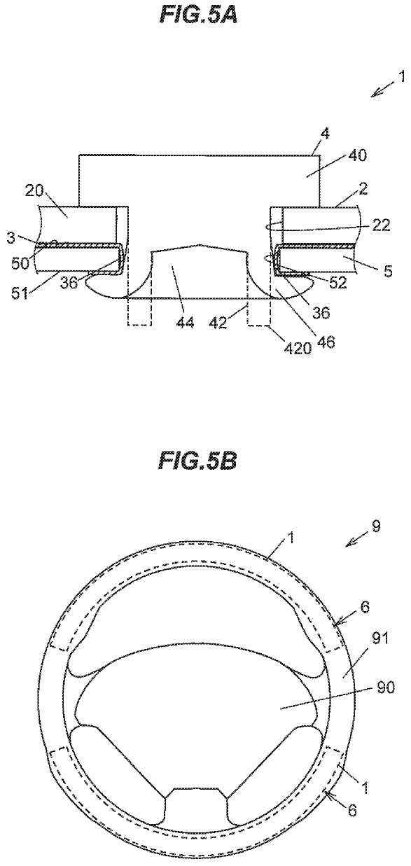

FIG. 4A is a schematic diagram illustrating an example of a connection structure according to a second embodiment before it is built up, and FIG. 4B is a schematic diagram illustrating an example where the connection structure is built up. FIG. 5A is a cross-sectional view of the example of the connection structure according to the second embodiment, and FIG. 5B is a schematic diagram illustrating an example of a steering wheel where the connection structure is disposed. In FIG. 5A, only the conductive member 3 is shaded with oblique lines. Broken lines in FIG. 5A indicate a distal end portion 420 of a rivet 4 before it is caulked. In the embodiment described below, parts having the same functions and configurations as in the first embodiment will be given the same reference numerals as in the first embodiment, and descriptions thereof will be omitted.

In a connection structure 1 of the embodiment, for example, as illustrated in FIGS. 4A and 4B, the conductive member 3 is made of a thin mesh-like sheet. A cut portion 35 of this conductive member 3 has a cruciform shape as an example.

In the connection structure 1, when a caulking portion 42 of the rivet 4 is inserted through an insertion hole 22 in a terminal 2, the cut portion 35 in the conductive member 3, and an insertion hole 52 in a washer 5 and is caulked, as illustrated in FIG. 5A, the distal end portion 420 of the caulking portion 42 is deformed outwards while entraining entrained portions 36 of the conductive member 3. The entrained portions 36, as a result of insertion of the rivet 4, pass through the insertion hole 52 in the washer 5 while being guided along a side surface of the caulking portion 42 and are bent round from a front surface 50 to a rear surface 51 of the washer 5.

This connection structure 1 can be used as a touch electrode of an electrostatic capacitive-type touch sensor 6. This touch sensor 6 is disposed, for example, on a rim portion 91 connected to a base portion 90 of a steering wheel 9 of a vehicle and detects whether the steering wheel 9 is gripped, as illustrated in FIG. 5B. FIG. 53 illustrates an example where the connection structure 1 is disposed at an upper portion and a lower portion of the steering wheel 9 as touch electrodes.

As a modified example, a plurality of connection structures 1 are further disposed on the steering wheel 9, whereby positions where the driver is gripping the steering wheel 9 can be detected in detail.

Since the rim portion 91 of the steering wheel 9 has a shape resulting from bending a cylindrical member into a round shape, it is difficult to dispose a touch electrode on this rim portion 91. However, since the connection structure 1 includes the thin mesh-like conductive member 3, the connection structure 1 can easily be disposed on a curved surface of the rim portion 91.

This touch sensor 6 is applied to a driving assist system for assisting the driving of the vehicle as an example. This driving assist system, for example, is configured to control the steering wheel 9 so that the vehicle is prevented from departing from a driving lane or to control the vehicle not to reduce an inter-vehicle distance.

### Effects of Second Embodiment

Since the conductive member 3 of this embodiment is the thin mesh-like member, it is difficult to cut out a hole through which the rivet 4 is passed. Additionally, since the conductive member 3 is the thin mesh-like member, it is difficult to be welded or soldered to the terminal 2 to establish an electrical continuity between the conductive member 3 and the terminal 2. With the connection structure 1 of this embodiment, however, since it is the cut portion 35 where the rivet 4 is inserted through, the portion where the rivet 4 is passed through can easily be formed, and an electrical continuity can easily be established between the conductive member 3 and the terminal 2.

As has been described above, since the connection structure 1 includes the conductive member 3 which is rich of flexibility, the connection structure 1 has a high following performance relative to the curved surface of the steering wheel 9. Consequently, the connection structure 1 can easily be disposed on the curved surface of the steering wheel 9 as a detection electrode of the touch sensor 6.

According to the connection structure 1 according to at least one of the embodiments that have been described heretofore, no mill end is produced, whereby an increase in production cost can be suppressed.

Although the embodiments and modified examples of the invention have been described above, these embodiments and modified examples are merely examples and do not limit the inventions set forth in claims below. Such novel embodiments and modified examples can be implemented in various other forms, and various omissions, substitutions, changes, and the like can be made without departing from the spirit and scope of the invention. In addition, all combinations of the features described in these embodiments and modified example are not necessary to solve the problem of the invention. Furthermore, these embodiments and modified examples are included within the spirit and scope of the invention and also within the scope of invention set forth in claims below and equivalents thereof.

### REFERENCE SIGNS LIST

1 Connection structure
2 Terminal
3 Conductive member
4 Rivet
6 Touch sensor
9 Steering wheel
20 Connecting portion
22 Insertion hole
24 Crimping portion
26 Electric wire
30 Front surface
31 Rear surface
35 Cut portion
36 Entrained portion
42 Caulking portion
44 Caulking cavity portion
420 Distal end portion

1. A connection structure, comprising:
a terminal with an electric wire attached thereto and with an insertion hole;
a sheet-shaped conductive member comprising a cut portion formed by being cut in to be pierced from a front surface to a rear surface thereof; and
a rivet swaged while inserting a swaged portion into the insertion hole and the cut portion and rolling together the conductive member of the cut portion to have a conduction between the terminal and the conductive member.

2. The connection structure according to claim 1, wherein the conductive member is a conductive cloth or a conductive sheet.

3. The connection structure according to claim 1, wherein the conductive member is a conductive cloth having a mesh configuration.

4. The connection structure according to claim 1, wherein the cut portion in the conductive member is formed by making one or a plurality of cuts rectilinearly or curvilinearly, the plurality of cuts intersecting.

5. A touch sensor, comprising the connection structure according to claim 1.

6. A method for forming a connection structure, comprising:
forming a cut portion in a sheet-shaped conductive member by cutting in the conductive member to be pierced from a front surface to a rear surface thereof;
disposing a terminal with an electric wire attached thereto and with an insertion hole on a front surface side of the conductive member;
inserting a swaged portion of a rivet into the insertion hole and the cut portion to stretch the conductive member of the cut portion towards a rear surface side thereof; and
swaging the rivet to deform a tip of the swaged portion such that the conductive member of the cut portion stretched towards the rear surface side of the conductive member is rolled together to have a conduction between the terminal and the conductive member.

7. The method for forming a connection structure according to claim 6, wherein the cut portion in the conductive member is formed by making one or a plurality of cuts rectilinearly or curvilinearly, the plurality of cuts intersecting.
